(19) United States
(12) Patent Application Publication
(10) Pub. No.: US 2017/0041662 A1
(43) Pub. Date: Feb. 9, 2017

(54) AUTOMOTIVE WIRELESS AUDIO AND/OR VIDEO MEDIA SERVER WITH INDEPENDENT BATTERY POWER

(71) Applicant: Panasonic Automotive Systems Company of America, Division of Panasonic Corporation of North America, Peachtree City, GA (US)

(72) Inventor: GERALD CLINTON DAVIS, FAYETTEVILLE, GA (US)

(21) Appl. No.: 15/221,158

(22) Filed: Jul. 27, 2016

Related U.S. Application Data
(60) Provisional application No. 62/201,174, filed on Aug. 5, 2015.

(51) Int. Cl. H04N 21/4363; A63F 13/235; H04N 21/4223; H04N 21/422; H04N 21/414; H04N 21/214; G08B 13/196

(52) U.S. Cl. CPC H04N 21/43637; H04N 21/214; A63F 13/235; G08B 13/19665; H04N 21/42221; H04N 21/41422; H04N 21/4223; H04N 21/42203; G08B 13/19695

(57) ABSTRACT

A media server for an automobile includes a radio frequency receiver wirelessly receiving audio and video content from a remote source. A processor is in communication with the receiver and stores the received audio and video content in a non-volatile memory device. A display screen is mounted in a rear seat of the automobile. A user interface receives inputs from a user and, in response thereto, causes the processor to present the video content on the display screen and present the audio content on a loudspeaker.

### CROSS-REFERENCED TO RELATED APPLICATIONS

This application claims benefit of U.S. Provisional Application No. 62/201,174 filed on Aug. 5, 2015, which the disclosure of which is hereby incorporated by reference in its entirety for all purposes.

### FIELD OF THE INVENTION

The disclosure relates to an electronic media server, and, more particularly, an electronic media server for use in a motor vehicle.

### BACKGROUND OF THE INVENTION

Currently, rear seat entertainment systems rely on DVD or Blu-Ray discs, which can get misplaced, stolen or scratched due to the bumps and vibration in a vehicle. Some systems may allow the user to play back video content stored on his Apple iPOD, smartphone or tablet. Use of a smartphone/tablet can consume a lot of battery power and tie up a phone that would normally be used for texting or phone conversations for passengers.

Streaming of video over a cellular or satellite (XM/Sirius) network is possible, but uses a lot of data from the end user's data plan, or requires a lot of precious bandwidth (cellular) or monthly fee (XM/Sirius). Such bandwidth may otherwise be used for music programming and does not enable video on demand for many customers.

Consumer DVRs allow users to record media content from cable, satellite or HDTV (over the air) for later home use, but do not enable recording of DVD or Blu-Ray discs. DVRs do not have an internal battery source or connectivity with vehicle networks. Nor are DVRs suitable for automotive use due to their use of rotating media HDD hard disk drives, which have high failure rates in an automotive environment (vibration, temperature, etc.).

### SUMMARY

The present invention may provide a wireless audio/video media server (e.g., an automotive DVR and/or Media Player) which enables legal downloads of audio and video files for playback in the vehicle. The invention can be incorporated in a rear seat entertainment system.

The invention provides a way to synchronize media files with a home or business wireless network or other Wi-Fi hot spot through the Internet, and allow playback of high resolution audio and/or video files downloaded by the user after purchasing a legal copy of a DVD or Blu-Ray disc. One possible download service is UltraViolet, which allows users to download a legal copy of the DVD/Blu-Ray in an encrypted file format that allows playback on other devices. (Disney has their own system called Disney Movies Anywhere). A library of video files can be stored on a solid state drive or other non-volatile memory. For example, up to 350 movies could be stored on a 256 GB solid state drive (SSD) in a compressed format such as H.264. A rechargeable Li-ion battery with related charging circuitry allows the system to stay powered for automatic synchronization with the user's network after the vehicle is powered off (e.g., in the garage) without draining the vehicle's battery. Current typical Wi-Fi 802.11a/g networks offer speeds up to 54 Mbps, so the time required to download one movie may be about 109 seconds (700 MB/54 Mbps). With newer 802.11n networks that offer download speeds up to 300 Mbps, a movie download may require about 20 seconds (700 MB/300 Mbps). State of the art 802.11ac networks offer speeds up to 1 Gbps, providing a movie download time of about seven seconds (700 MB/1 Gbps). An optional Advanced Television Systems Committee (ATSC) receiver enables recording of over-the-air HDTV digital content directly to the system (e.g., when the vehicle is parked). An infrared or RF remote control receiver enables user control and programming of the rear entertainment system. Another source of video may be a forward-facing camera or other camera used for security purposes to monitor the car in case of burglary or theft. The camera, microphone and recording system may turn on automatically in case of intrusion detection. A Bluetooth transceiver enables wireless audio transmission and/or user wireless input for gaming purposes. Thus, the media server can function as an upgradeable gaming console.

The software running on the microprocessor may include an operating system capable of creating a media file system, and software codecs for audio playback: (MP3, AAC, OggVorbis, WAV, FLAC, WMA, M4A, etc.) and H.264. MPEG, AVI, WMV, RealVideo, and Common File Format (UltraViolet), etc.). Thus, the media server can play back high resolution audio files, and play back video files accessed from the home network and stored on the local solid state memory.

In one embodiment, the invention comprises a media server for an automobile, including a radio frequency receiver wirelessly receiving audio and video content from a remote source. A processor is in communication with the receiver and stores the received audio and video content in a non-volatile memory device. A display screen is mounted in a rear seat of the automobile. A user interface receives inputs from a user and, in response thereto, causes the processor to present the video content on the display screen and present the audio content on a loudspeaker.

In another embodiment, the invention comprises a method of providing audio and/or video content in a motor vehicle, including wirelessly receiving, within the vehicle, audio and video content from a remote source. The received audio and video content is stored in a non-volatile memory device within the vehicle. Inputs are received from a user via a user interface within the vehicle. In response to receiving the inputs from the user, the audio and video content is retrieved from the non-volatile memory device. The video content is presented on a display screen within the vehicle, and the audio content is presented on a loudspeaker or wireless headphones within the vehicle.

In yet another embodiment, the invention comprises a motor vehicle including a media server having a radio frequency receiver wirelessly receiving audio and video content from a source outside of the vehicle. A non-volatile memory device stores the received audio and video content. A display screen and a loudspeaker are disposed in the vehicle. A processor is coupled to the memory device, the display screen and the loudspeaker. A remote control receives manual inputs from a user and, in response thereto, transmits signals to the processor to playback the video content on the display screen and playback the audio content on the loudspeaker or wireless headphones.

An advantage of the present invention is that it frees up a smartphone or tablet for use by the passengers of the vehicle, and the battery lives of such devices are preserved.

### BRIEF DESCRIPTION OF THE DRAWINGS

A better understanding of the present invention will be had upon reference to the following description in conjunction with the accompanying drawings.

FIG. 1 is a block diagram of one example embodiment of an automotive wireless audio/video media server of the present invention.

FIG. 2 is a flow chart of one example embodiment of method of the present invention for providing audio and/or video content in a motor vehicle.

### DETAILED DESCRIPTION OF THE PREFERRED EMBODIMENTS

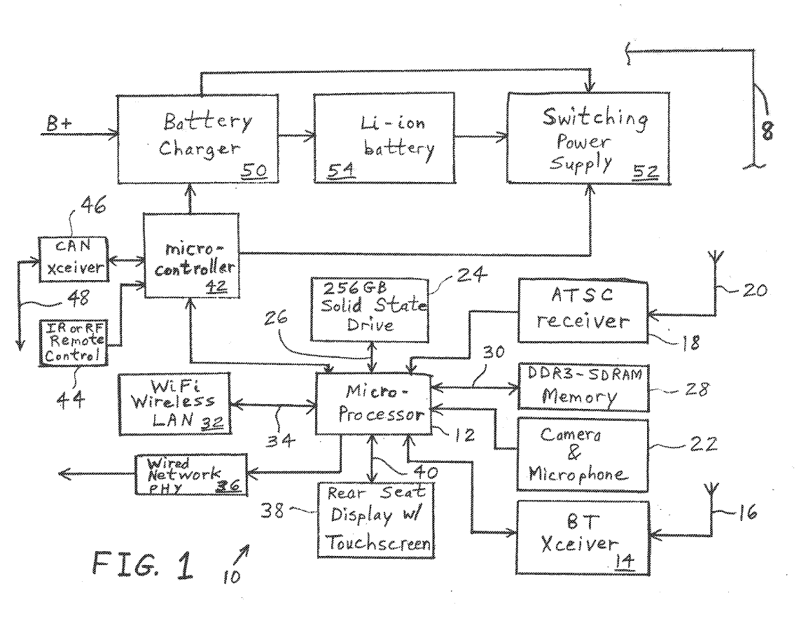

FIG. 1 illustrates one embodiment of a motor vehicle 8 including an automotive wireless audio/video media server 10 of the present invention. Double arrows indicate bi-directional communication between blocks. Server 10 includes a microprocessor 12 receiving content from a Bluetooth transceiver 14 that is connected to an antenna 16. Bluetooth transceiver 14 accommodates wireless transmission of audio content and/or wireless inputs from a user for supporting video games. Thus, Bluetooth transceiver 14 enables media server 10 to function as a gaming console that can be upgraded.

Microprocessor 12 may also receive content from an optional ATSC receiver 18 for HDTV recording. ATSC receiver 18 is connected to an antenna 20 and may record over-the-air HDTV digital content, perhaps only when the vehicle is parked or the engine ignition is off (e.g., a DVR recording could be set up in advance to record primetime shows while the vehicle is parked in the home garage).

A camera and microphone 22 may also provide video content to processor 12. The camera may be forward-facing and incorporated in a vehicle security system that transmits an alarm signal in the event the vehicle is burglarized or stolen. The camera, microphone and recording system may automatically begin operating in response to detecting an intrusion or other breach of security. Camera and a microphone 22 are associated with the passenger compartment of the automobile and may begin capturing video content and audio content, respectively, in response to a security system of the automobile detecting a security breach, and may store the captured video content and audio content in non-volatile memory device 24.

A solid state drive 24 or embedded Multimedia Card (eMMC) media storage device (e.g., NAND Flash memory) may store a library of video files. For example, up to 350 movies could be stored on a 256 GB drive 24 in a compressed format such as H.264, or based on Ultraviolet Common File Format with no streaming. One movie occupies about 700 MB with compressed video storage, such as with H.264 video compression format. Communication between drive 24 and processor 12 may be via a serial advanced technology attachment (SATA) serial interface 26, which may be an integrated managed NAND Flash device. Alternatively, communication between drive 24 and processor 12 may be via an eMMC embedded Multi-Media Controller interface for an integrated managed NAND Flash memory device (up to 128 GB eMMC devices are currently available).

Microprocessor 12 may be in communication with a double data rate type three synchronous dynamic random-access memory (DDR3 SDRAM) 28 via a thirty-two or sixty-four-bit data bus interface 30. Microprocessor 12 may be in communication with a Wi-Fi wireless LAN 32, as indicated at 34, via a peripheral component interconnect express (PCIe) high-speed serial computer expansion bus standard.

Microprocessor 12 may produce audio output to amplifiers and/or loudspeakers via a wired network physical layer 36. Microprocessor 12 may produce video output to a rear seat display 38 with a touchscreen via the low-voltage differential signaling (LVDS) standard flat panel display link III (FPD-Link III) 40.

Microprocessor 12 may be in communication with a microcontroller 42 that receives inputs from an infrared or radio frequency remote control 44. Remote control 44 may transmit command signals to microprocessor 12 in response to receiving inputs from a user via a user interface of remote control 44. The user's inputs may change the presentation parameters of the audio and video content being played back on display 38 and the loudspeaker. Microcontroller 42 also communicates with a controller area network (CAN) transceiver 46 which, in turn, communicates with a vehicle network 48.

Microcontroller 42 also provides inputs to a battery charger 50 and a switching power supply 52. Battery charger 50 receives a vehicle battery voltage B+, charges a lithium-ion or similar rechargeable battery 54, and provides power to switching power supply 52. The rechargeable Li-ion battery 54 and the related charging circuitry enables the system to remain powered on during automatic synchronization with the user's home network after the vehicle ignition is powered off (e.g., in the garage of the user's house) without draining the vehicle's battery.

During use near the user's home, microprocessor 12 may download video and/or audio content from a user's home entertainment system via WIFI transceiver 46, and may store the content in solid state drive 24. Later, when the vehicle is away from the user's home, microprocessor 12 may retrieve the video and/or audio content from the solid state drive 24, and may playback the content on display screen 38 and loudspeakers within the vehicle passenger compartment. Microprocessor 12 may also download video and/or audio content from a download service such as UltraViolet via WIFI—home network or Public HotSpot.

Microprocessor 12 may receive video game inputs from a user via Bluetooth transceiver 14. Bluetooth transceiver 14 may transmit gaming command signals to microprocessor 12 in response to receiving inputs from a user.

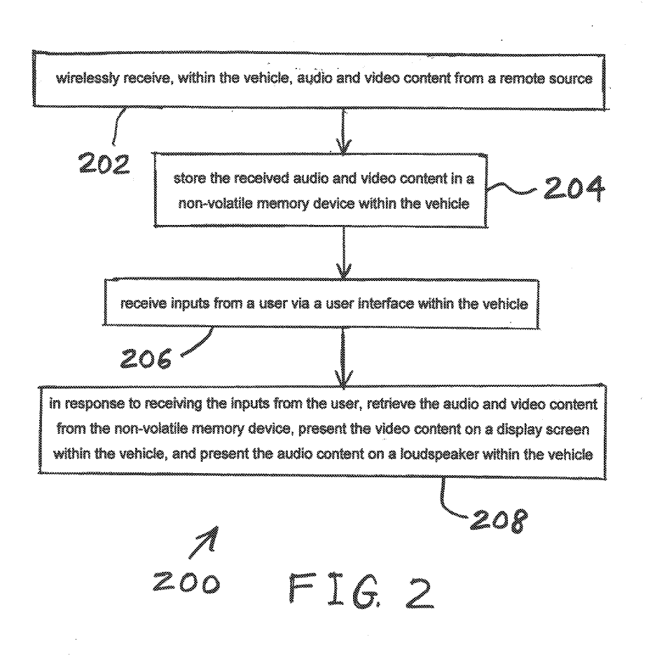

FIG. 2 illustrates one example embodiment of method 200 of the present invention for providing audio and/or video content in a motor vehicle. In a first step 202, audio and video content are wirelessly received, within the vehicle, from a remote source. For example, during use of server 10 near the user's home, microprocessor 12 may download video and/or audio content from a user's home entertainment system via WIFI transceiver 46.

Next, in step 204, the received audio and video content is stored in a non-volatile memory device within the vehicle. That is, the video and/or audio content downloaded from the user's home entertainment system may be stored in solid state drive 24.

In step 206, inputs are received from a user via a user interface within the vehicle. For example, microprocessor 12 may be in communication with a microcontroller 42 that receives inputs from an infrared or radio frequency remote control 44 disposed within vehicle 8. Remote control 44 may transmit command signals to microprocessor 12 in response to receiving inputs from a user via a user interface of remote control 44.

In a last step 208, in response to receiving the inputs from the user, the audio and video content is retrieved from the non-volatile memory device, the video content is presented on a display screen within the vehicle, and the audio content is presented on a loudspeaker within the vehicle. For example, the user's inputs from remote control 44 may cause the audio and video content to be retrieved from solid state drive 24, the audio content may be played back on the loudspeaker, and the video content may be played back on display 38.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A media server for an automobile, the server comprising:
a radio frequency receiver configured to wirelessly receive audio and video content from a remote source;
a non-volatile memory device;
a processor in communication with the receiver and configured to store the received audio and video content in the memory device;
a display screen configured to be mounted in a rear seat of the automobile;
a loudspeaker; and
a user interface configured to receive inputs from a user and, in response thereto, cause the processor to present the video content on the display screen and present the audio content on the loudspeaker.

2. The media server of claim 1 wherein the radio frequency receiver comprises a WIFI transceiver, and the remote source comprises a user's home entertainment system.

3. The media server of claim 1 wherein the radio frequency receiver comprises an Advanced Television Systems Committee (ATSC) receiver, and the remote source comprises a television broadcast service.

4. The media server of claim 1 wherein the non-volatile memory device comprises a solid state drive having a storage capacity of at least 8 Gigabytes.

5. The media server of claim 1 wherein the non-volatile memory device comprises an embedded Multimedia Card.

6. The media server of claim 1 further comprising a media server battery configured to power the media server while the media server is not powered by a primary battery of the automobile.

7. The media server of claim 1 further comprising a camera and a microphone associated with the automobile and configured to begin capturing video content and audio content, respectively, in response to a security system of the automobile detecting a security breach, and to store the captured video content and audio content in the non-volatile memory device.

8. The media server of claim 1 wherein the user interface comprises a remote control configured to transmit command signals to the processor in response to receiving inputs from a user.

9. The media server of claim 1 further comprising a Bluetooth transceiver configured to transmit gaming command signals to the processor in response to receiving inputs from a user.

10. A method of providing audio and/or video content in a motor vehicle, the method comprising:
wirelessly receiving, within the vehicle, audio and video content from a remote source;
storing the received audio and video content in a non-volatile memory device within the vehicle;
receiving inputs from a user via a user interface within the vehicle; and
in response to receiving the inputs from the user, retrieving the audio and video content from the non-volatile memory device, presenting the video content on a display screen within the vehicle, and presenting the audio content on a loudspeaker within the vehicle.

11. The method of claim 10 further comprising providing electrical power for the wirelessly receiving, storing, and receiving steps by use of a media server battery while an engine of the vehicle is not running, the media server battery being separate from a primary battery of the vehicle.

12. The method of claim 10 further comprising:
detecting a security breach associated with the vehicle;
using a camera and a microphone within the vehicle to capture video content and audio content, respectively, in response the detecting of the security breach; and
storing the captured video content and audio content in the non-volatile memory device.

13. The method of claim 10 further comprising receiving command signals from a user via a remote control, the command signals being directed to parameters of the presentation of the video content and the audio content.

14. The method of claim 10 further comprising receiving gaming command signals from a user via a Bluetooth transceiver.

15. A motor vehicle comprising a media server including:
a radio frequency receiver configured to wirelessly receive audio and video content from a source outside of the vehicle;
a non-volatile memory device configured to store the received audio and video content;
a display screen disposed in the vehicle;
a loudspeaker disposed in the vehicle;
a processor coupled to the memory device, the display screen and the loudspeaker; and
a remote control configured to receive manual inputs from a user and, in response thereto, transmit signals to the processor to playback the video content on the display screen and playback the audio content on the loudspeaker.

16. The motor vehicle of claim 15 wherein the radio frequency receiver comprises a controller area network (CAN) transceiver, and the source outside of the vehicle comprises a user's home entertainment system.

17. The motor vehicle of claim 15 wherein the radio frequency receiver comprises an Advanced Television Systems Committee (ATSC) receiver, and the source outside of the vehicle comprises a television broadcast service.

18. The motor vehicle of claim 15 further comprising a media server battery configured to power the media server while the media server is not powered by a primary battery of the automobile.

19. The motor vehicle of claim 15 further comprising a camera and a microphone associated with the motor vehicle and configured to begin capturing video content and audio content, respectively, in response to a security system of the motor vehicle detecting a security breach, and to store the captured video content and audio content in the non-volatile memory device.

20. The motor vehicle of claim 15 further comprising a Bluetooth transceiver configured to transmit gaming command signals to the processor in response to receiving inputs from a user.
